(19) United States
(12) Patent Application Publication
(10) Pub. No.: US 2014/0313451 A1
(43) Pub. Date: Oct. 23, 2014

(54) LIQUID CRYSTAL DISPLAY DEVICE

(71) Applicants: Jin Nakamura, Osaka-shi (JP); Hiromi Enomoto, Osaka-shi (JP)

(72) Inventors: Jin Nakamura, Osaka-shi (JP); Hiromi Enomoto, Osaka-shi (JP)

(73) Assignee: SHARP KABUSHIKI KAISHA, Osaka-shi, Osaka (JP)

(21) Appl. No.: 14/116,842

(22) PCT Filed: May 14, 2012
(86) PCT No.: PCT/JP2012/062281

§ 371 Date: Nov. 11, 2013

(30) Foreign Application Priority Data
May 19, 2011 (JP) 2011-112656

(51) Int. Cl. G02F 1/1333

(52) U.S. Cl. CPC G02F 1/133308
USPC 349/58

(57) ABSTRACT

A liquid crystal display device includes a liquid crystal display panel having a display region and including two substrates, and a cover transparent member placed on and bonded to the liquid crystal display panel with an adhesive sheet interposed therebetween. The cover transparent member has a frame region in the vicinity of its outer edge. In the frame region, a coloring coating formed on the cover transparent member is arranged and made of a material the same as a material for a first reference member, the first reference member being any member arranged in the form of a film to adhere to a surface of one of the two substrates of the liquid crystal display panel. The adhesive sheet covers the cover transparent member while contacting the coloring coating.

### TECHNICAL FIELD

The present invention relates to liquid crystal display devices.

### BACKGROUND ART

Two glass substrates bonded together to sandwich a liquid crystal layer between them is referred to as a “liquid crystal display panel.” The liquid crystal display panel is described, for example, in Japanese Patent Laying-Open No. 2008-176237 (Patent Document 1). A liquid crystal display device having a cover glass bonded to a surface of the liquid crystal display panel to improve the appearance is also known. A specific color may be applied to a so-called frame region of the appearance of such a liquid crystal display device. A black color is applied, for example.

FIG. 8 shows an example of a structure in the vicinity of a frame region of a liquid crystal display device according to conventional techniques. A cover glass 75 is bonded to a surface of a liquid crystal display panel 3 with an adhesive tape 74 interposed therebetween. A liquid crystal display device 901 has a display region 1. A frame region 2 is provided on the outer side of display region 1. In a portion of a rear surface of cover glass 75 that corresponds to frame region 2, a black color region is formed by printing. If the black color region is formed by printing, a paint layer 76 is formed. Paint layer 76 has a thickness of about 10 μm.

Cover glass 75 having the printed black color region is bonded to liquid crystal display panel 3 with adhesive tape 74. At this time, cover glass 75 is arranged so that the surface on which paint layer 76 has been formed faces toward liquid crystal display panel 3.

### CITATION LIST

### Patent Document

PTD 1: Japanese Patent Laying-Open No. 2008-176237

### SUMMARY OF INVENTION

### Technical Problem

As paint layer 76 of the black color region printed in the frame portion has a thickness of about 10 μm, the end of paint layer 76 has a stepped portion of about 10 μm. When adhesive tape 74 is adhered to cover glass 75, adhesive tape 74 cannot completely follow this stepped portion, causing the formation of minute space as shown in FIG. 8. This minute space serves as a bubble 77. Bubble 77 enters display region 1 when spread, resulting in lower display quality. In addition, as the presence of bubble 77 leads to degradation of appearance, liquid crystal display device 901 is rendered defective, resulting in a lower yield.

An object of the present invention, therefore, is to provide a liquid crystal display device in which bubbles resulting in lower display quality and a lower yield tend not to be generated even when a transparent member to serve as a cover is bonded to the surface of a liquid crystal display panel.

### Solution to Problem

In order to attain the object described above, a liquid crystal display device according to the present invention includes a liquid crystal display panel having a display region and including two substrates, and a cover transparent member placed on and bonded to the liquid crystal display panel with an adhesive sheet interposed therebetween. The cover transparent member has a frame region in the vicinity of its outer edge. In the frame region, a coloring coating formed on the cover transparent member is arranged and made of a material the same as a material for a first reference member, the first reference member being any member arranged in the form of a film to adhere to a surface of one of the two substrates of the liquid crystal display panel. The adhesive sheet covers the cover transparent member while contacting the coloring coating.

### Advantageous Effects of Invention

According to the present invention, the coloring coating can be formed with an extremely small thickness by using a step the same as a step of forming the first reference member on the surface of the substrate of the liquid crystal display panel, thereby reducing the stepped portion. As a result, bubbles tend not to be generated even when the adhesive sheet is adhered in contact with the coloring coating.

### BRIEF DESCRIPTION OF DRAWINGS

FIG. 1 is a perspective view of a liquid crystal display device in a first embodiment according to the present invention.

FIG. 2 is a cross-sectional view in the vicinity of a frame region of the liquid crystal display device in the first embodiment according to the present invention.

FIG. 3 is a plan view of a surface of a substrate included in the liquid crystal display device in the first embodiment according to the present invention.

FIG. 4 is a perspective view of a liquid crystal display device in a second embodiment according to the present invention.

FIG. 5 is a cross-sectional view in the vicinity of a frame region of the liquid crystal display device in the second embodiment according to the present invention.

FIG. 6 is a cross-sectional view in a first stage of a process in the vicinity of the frame region of a rear surface of a cover transparent member used in the liquid crystal display device in the second embodiment according to the present invention.

FIG. 7 is a cross-sectional view in a second stage of the process in the vicinity of the frame region of the rear surface of the cover transparent member used in the liquid crystal display device in the second embodiment according to the present invention.

FIG. 8 is a cross-sectional view in the vicinity of a frame region of a liquid crystal display device according to conventional techniques.

### DESCRIPTION OF EMBODIMENTS

(First Embodiment)

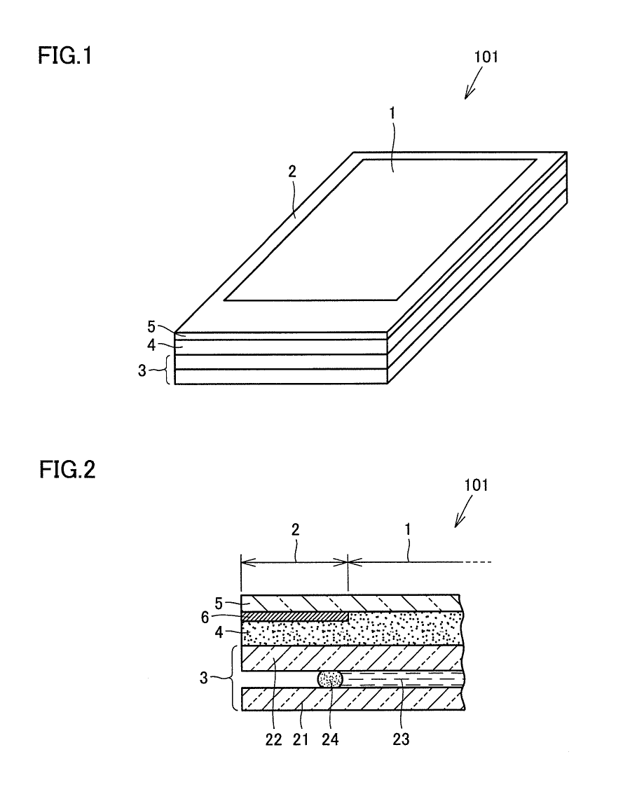

Referring to FIGS. 1 to 3, a liquid crystal display device in a first embodiment according to the present invention will be described. FIG. 1 shows a liquid crystal display device 101 according to this embodiment in its entirety. Liquid crystal display device 101 includes a liquid crystal display panel 3 having a display region 1 and including two substrates 21 and 22, and a cover transparent member 5 placed on and bonded to liquid crystal display panel 3 with an adhesive sheet 4 interposed therebetween. Cover transparent member 5 has a frame region 2 in the vicinity of its outer edge. FIG. 2 shows a cross-sectional view in the vicinity of frame region 2 of liquid crystal display device 101. In frame region 2, a coloring coating 6 formed on cover transparent member 5 is arranged and made of a material the same as a material for a first reference member, the first reference member being any member arranged in the form of a film to adhere to a surface of one of two substrates 21 and 22 of liquid crystal display panel 3. Adhesive sheet 4 covers cover transparent member 5 while contacting coloring coating 6.

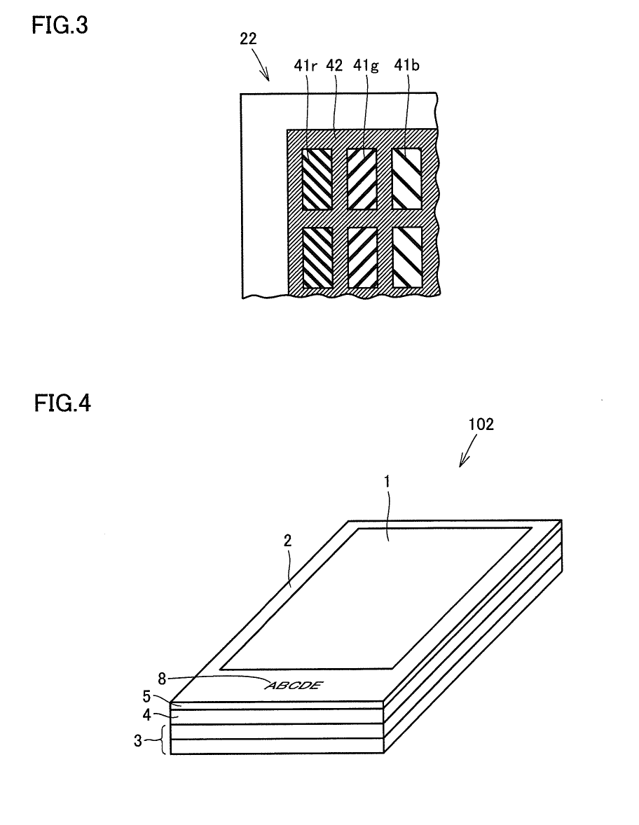

Liquid crystal display panel 3 includes a liquid crystal layer 23 between two substrates 21 and 22. Liquid crystal layer 23 is surrounded by a sealing material 24. Two substrates 21 and 22 may be glass substrates. For example, substrate 21 is a so-called TFT substrate and substrate 22 is a so-called color filter substrate. Although the first reference member is not shown in FIG. 2, the first reference member may be any of known members in the structure of common liquid crystal display panel 3. As shown in FIG. 3, for example, color filters 41r, 41g and 41b printed in an ink jet method and the like are arranged on a surface of substrate 22 facing toward liquid crystal layer 23. A black matrix 42 is formed in the shape of a lattice so as to separate color filters 41r, 41g and 41b from each other. Black matrix 42 serves as a light shielding film and is formed as a metal film by sputtering. Black matrix 42 is made of chromium, for example.

Cover transparent member 5 may be a plate member made of glass, for example. Cover transparent member 5 may be a so-called cover glass.

Adhesive sheet 4 may be an adhesive tape. Adhesive sheet 4 may be in any form that allows the bonding between cover transparent member 5 and liquid crystal display panel 3, without being limited to the form of a tape. Adhesive sheet 4 is thus provided herein.

The first reference member may be black matrix 42. If black matrix 42 is formed on substrate 22 by sputtering of chromium, for example, coloring coating 6 may be formed on cover transparent member 5 also by sputtering of chromium.

In this embodiment, in frame region 2 of cover transparent member 5, coloring coating 6 formed on cover transparent member 5 is arranged and made of the material the same as the material for the first reference member of liquid crystal display panel 3. Such coloring coating 6 can be advantageously formed by applying a step the same as a step of forming the first reference member on the surface of the substrate of liquid crystal display panel 3. In some cases, the same apparatus may be used. Since a film formed on the substrate of liquid crystal display panel 3 has a thickness smaller than that of paint layer 76 formed on cover glass 75 by ordinary printing in conventional liquid crystal display device 901, coloring coating 6 can be formed with an extremely small thickness. If the first reference member is black matrix 42, for example, coloring coating 6 can be formed with a thickness of 100 nm, which is equal to 1/100 of the thickness of conventional paint layer 76.

It is to be noted that the color of coloring coating 6 is not limited to be black, but may be various colors.

In this manner, the layer formed on the rear surface of cover transparent member 5 in frame region 2 can be made thinner than conventional paint layer 76, thereby reducing the stepped portion. As a result, bubbles tend not to be generated even when adhesive sheet 4 is adhered in contact with coloring coating 6, as shown in FIG. 2.

Liquid crystal display device 101 can be fabricated such that bubbles resulting in lower display quality and a lower yield tend not to be generated even when the transparent member to serve as a cover is bonded to the surface of the liquid crystal display panel.

As has been described to an extent in this embodiment, preferably, one of two substrates 21 and 22 included in liquid crystal display panel 3 is a color filter substrate on which color filters 41r, 41g and 41b are formed so that they are separated from each other by black matrix 42 so as to correspond to a plurality of pixels arranged in display region 1, and the first reference member is color filters 41r, 41g and 41b, or black matrix 42. By employing this structure, coloring coating 6 can be desirably formed on the rear surface of cover transparent member 5 by applying the apparatus and step for forming color filters 41r, 41g and 41b or black matrix 42 on the color filter substrate.

The first reference member may be one of color filters 41r, 41g and 41b. In this case, frame region 2 of liquid crystal display device 101 assumes a color such as red, green or blue. The first reference member may be two or more of color filters 41r, 41g and 41b. In this case, frame region 2 of liquid crystal display device 101 may have a pattern in which two or more colors of red, green and blue are present and arranged.

Although cover transparent member 5 is described as a plate member made of glass in this embodiment, the plate member made of glass may be replaced by a plate member made mainly of resin, which is advantageously resistant to breaking. Alternatively, cover transparent member 5 may be an acrylic plate. An acrylic plate is advantageously inexpensive, has a lighter weight, and is resistant to breaking.

(Second Embodiment)

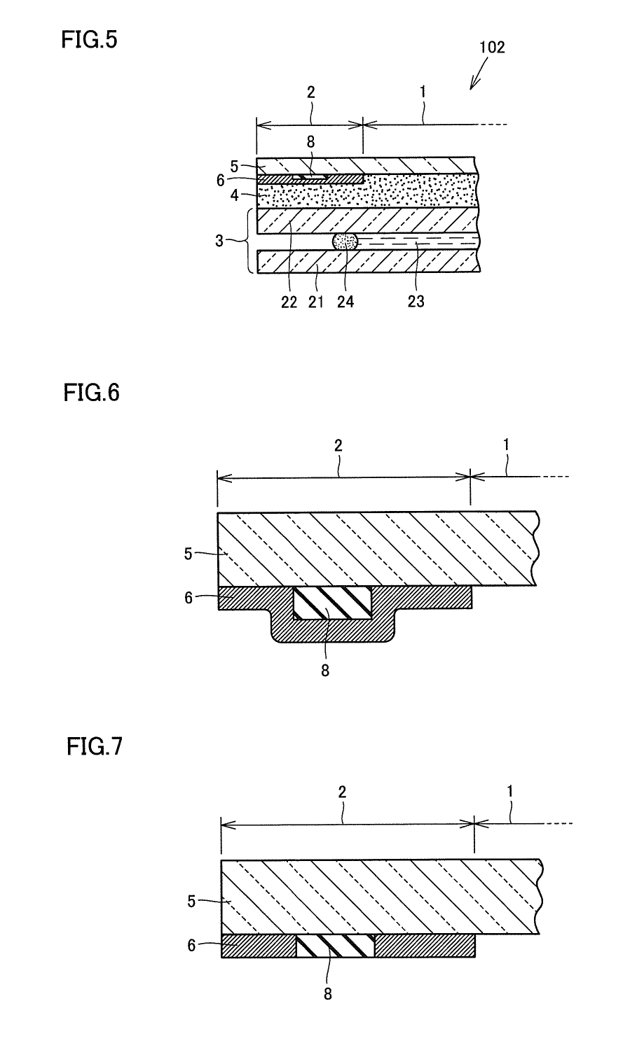

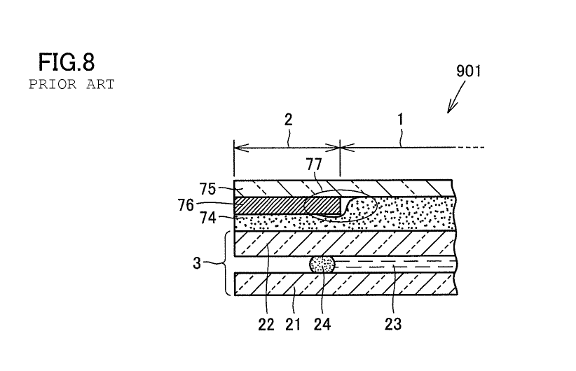

Referring to FIGS. 4 and 5, a liquid crystal display device in a second embodiment according to the present invention will be described. FIG. 4 shows a liquid crystal display device 102 according to this embodiment in its entirety. Liquid crystal display device 102 according to this embodiment is basically similar to liquid crystal display device 101 described in the first embodiment, but is different in that it includes an identification information display unit 8. FIG. 5 shows a cross-sectional view in the vicinity of frame region 2 of liquid crystal display device 102. In liquid crystal display device 102, cover transparent member 5 has identification information display unit 8 in frame region 2. Identification information display unit 8 is a coating formed to directly adhere to cover transparent member 5 on a surface of cover transparent member 5 on which coloring coating 6 is formed, and is made of a material the same as a material for a second reference member, the second reference member being any material arranged to adhere to a surface of one of two substrates 21 and 22 of liquid crystal display panel 3. Although identification information display unit 8 displays characters in the example shown in FIG. 4, identification information display unit 8 is not limited to characters but may be symbols, marks, paintings and the like. In the example shown in FIGS. 4 and 5, the coating is formed in the shape of a character spring which indicates the name of a manufacturer of this liquid crystal display device.

In this embodiment, in frame region 2 of cover transparent member 5, identification information display unit 8 is made of the material the same as the material for the second reference member of liquid crystal display panel 3. Such identification information display unit 8 can be advantageously formed by applying a step the same as a step of forming the second reference member on the surface of the substrate of liquid crystal display panel 3. In some cases, the same apparatus may be used.

For example, the second reference member may be a so-called gate electrode. Alternatively, the second reference member may be a color filter. Since such film is formed with an extremely small thickness, the stepped portion on the rear surface of cover transparent member 5 is not increased. As a result, bubbles tend not to be generated even when adhesive sheet 4 is adhered in contact with coloring coating 6, as shown in FIG. 5. Therefore, liquid crystal display device 102 can be fabricated such that bubbles resulting in lower display quality and a lower yield tend not to be generated even when the transparent member to serve as a cover is bonded to the surface of the liquid crystal display panel.

As has been described to an extent in this embodiment, preferably, one of two substrates 21 and 22 included in liquid crystal display panel 3 is a TFT substrate on which a thin film transistor is provided corresponding to at least one of the plurality of pixels arranged in display region 1, the thin film transistor has a gate electrode, and the second reference member is the gate electrode. By employing this structure, identification information display unit 8 can be desirably formed on the rear surface of cover transparent member 5 by applying the apparatus and step for forming the gate electrode on the TFT substrate. Metal layers formed simultaneously with the formation of a layer which will be the gate electrode on the substrate of the TFT substrate are collectively referred to as “gate metal.” By forming identification information display unit 8 on the rear surface of cover transparent member 5 by applying the apparatuses and steps for forming the gate metal, identification information display unit 8 can be formed with an extremely small thickness.

The same applies when the second reference member is a color filter. The second reference member may be one or a plurality of color filters 41r, 41g and 41b. The selection may be made as appropriate depending on the color to be displayed in identification information display unit 8.

Depending on the selection, the second reference member may be thicker than the first reference member. In this case, identification information display unit 8 made of the same material as that for the second reference member may be thicker than coloring coating 6 made of the same material as that for the first reference member. Although coloring coating 6 covers and hides identification information display unit 8 in the example shown in FIG. 5, coloring coating 6 may not be able to cover and hide identification information display unit 8 in this manner if identification information display unit 8 is thicker than coloring coating 6. In this case, if identification information display unit 8 is formed first and coloring coating 6 is formed thereafter, for example, a state such as shown in FIG. 6 is obtained immediately after the formation of coloring coating 6. In such a case, the rear surface of cover transparent member 5 may be polished to some extent in the state shown in FIG. 6. Consequently, as shown in FIG. 7, the portion of coloring coating 6 covering identification information display unit 8 is removed, causing identification information display unit 8 to be substantially flush with coloring coating 6. After this process, cover transparent member 5 and liquid crystal display panel 3 may be bonded together with adhesive sheet 4. Since identification information display unit 8 is not covered with coloring coating 6, identification information display unit 8 will appear as a transparent portion if identification information display unit 8 is translucent.

Depending on the aesthetic appearance to be represented as a liquid crystal display device, the first reference member and the second reference member may be selected as appropriate from the various types of films formed on the liquid crystal display panel.

Although one of two substrates 21 and 22 included in liquid crystal display panel 3 is described as a TFT substrate and the other as a color filter substrate in the embodiments described above, another combination may be employed.

The embodiments disclosed herein are illustrative and non-restrictive in every respect. The scope of the present invention is defined by the terms of the claims, rather than the description above, and is intended to include any modifications within the scope and meaning equivalent to the terms of the claims.

### INDUSTRIAL APPLICABILITY

The present invention is applicable to a liquid crystal display device.

### REFERENCE SIGNS LIST

1 display region; 2 frame region; 3 liquid crystal display panel; 4 adhesive sheet; 5 cover transparent member; 6 coloring coating; 8 identification information display unit; 21, 22 substrate; 41r, 41g, 41b color filter; 42 black matrix; 74 adhesive tape; 75 cover glass; 76 paint layer; 77 bubble; 101, 102 liquid crystal display device; 901 (conventional) liquid crystal display device.

1. A liquid crystal display device comprising:
a liquid crystal display panel having a display region and including two substrates; and
a cover transparent member placed on and bonded to said liquid crystal display panel with an adhesive sheet interposed therebetween, said cover transparent member having a frame region in the vicinity of its outer edge,
in said frame region, a coloring coating formed on said cover transparent member being arranged and made of a material the same as a material for a first reference member, said first reference member being any member arranged in the form of a film to adhere to a surface of one of said two substrates of said liquid crystal display panel, said adhesive sheet covering said cover transparent member while contacting said coloring coating.

2. The liquid crystal display device according to claim 1, wherein
one of said two substrates is a color filter substrate on which color filters are formed so that they are separated from each other by a black matrix so as to correspond to a plurality of pixels arranged in said display region, and
said first reference member is said color filters or said black matrix.

3. The liquid crystal display device according to claim 1, wherein
said cover transparent member has an identification information display unit in said frame region, said identification information display unit being a coating formed to directly adhere to said cover transparent member on a surface of said cover transparent member on which said coloring coating is formed, and being made of a material the same as a material for a second reference member, said second reference member being any material arranged to adhere to a surface of one of said two substrates of said liquid crystal display panel.

4. The liquid crystal display device according to claim 3, wherein
one of said two substrates is a TFT substrate on which a thin film transistor is provided corresponding to at least one of the plurality of pixels arranged in said display region, said thin film transistor having a gate electrode, and
said second reference member is said gate electrode.

5. The liquid crystal display device according to claim 1, wherein
said cover transparent member is made mainly of resin.

6. The liquid crystal display device according to claim 5, wherein
said cover transparent member is an acrylic plate.
